(19) United States
(12) Patent Application Publication
(10) Pub. No.: US 2004/0167034 A1
(43) Pub. Date: Aug. 26, 2004

(54) Emulsion and dispersion formulations and method

(76) Inventors: John Wayne Coote, Ingleside, NSW (AU); Miles David Wayne, South Curl Curl, NSw (AU); Hubertus Leonardus Regtop, Mittagong, NSW (AU); John Raymond Biffin, Berrima, NSW (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/478,155

(22) PCT Filed: May 17, 2002
(86) PCT No.: PCT/AU02/00605

(30) Foreign Application Priority Data
May 18, 2001 (AU) PR 5100

(51) Int. Cl. A01N 25/00

(52) U.S. Cl. 504/358

(57) ABSTRACT

The present invention provides a process of preparing an emulsion of a solubilised compound, said compound being soluble in a physiologically acceptable aqueous or nonaqueous solvent, said process comprising: (1) adding a complexing agent to at least one said solvent containing at least one said compound, the agent being capable of forming a compound: agent complex; (b) adding an emulsifier to the solvent containing the compound and the complexing agent; and (c) forming an emulsion. The present invention also provides a process of preparing a dispersion of a compound which is insoluble in a physiologically acceptable aqueous or nonaqueous solvent but only soluble in a physiologically unacceptable solvent, said process comprising: (a) adding said compound to at least one physiologically acceptable solvent; (b) adding a complexing agent to the compound plus solvent of (a); (c) further adding an emulsifier to the compound plus solvent plus complexing agent of (b); (d) forming a dispersion of said compound in said physiologically acceptable solvent.

### TECHNICAL FIELD

The present invention relates to a process of preparing an emulsion, an emulsion when prepared by such a process, a composition comprising the emulsion, and a method of administering a compound to an animal or human.

### BACKGROUND ART

There are many compounds which, while possessing desirable pharmaceutical and/or cosmetic and/or other properties are nevertheless not able to be made biologically available due to the insolubility in a particular medium chosen. This also applies to conventional pharmaceutical drugs of which 40% are classified as insoluble.

For example, flavonoids phytosterols, carotenoids, tocopherols and other phytochemicals are classes of compounds isolated from plants with recognised pharmacological properties. Flavonoids demonstrate anti-inflammatory and anti-histamine properties and also can act as platelet aggregation inhibitors. They are able to decrease capillary fragility and demonstrate free radical scavenging properties. Flavonoids are also known to inhibit enzyme systems such as lipooxygenase, cyclooxygenase, aldose reductase, and phosphodiesterases.

Phytosterols are cholesterol like molecules which have anti-inflammatory properties as well as modulating the immune system and have the ability to lower cholesterol. Flavonoids phyotosterols, carotenoids, tocopherols and other phytochemicals have severe pharmaceutical limitations based on their poor absorption either orally or topically.

There have been many attempts to increase the bioavailability of compounds such as flavonoids, phytosterols and carotenoids which are typically isolated from plant extracts. Relatively few pharmacokinetic studies have been performed in humans. These studies demonstrated that quercetin is extremely poorly absorbed and is degraded by intestinal bacteria. Other studies indicated that derivatisation of the phenolic hydroxyls eg. hydroxy ethyl rutosides are less susceptible to degradation by intestinal bacteria and hence can be absorbed to a significant extent.

Specific tracer studies have shown that polyphenols, flavonoids, tocopherols, phytosterols and carotenoids which are present in the lipid fraction of the cytoplasmic membranes are located within the phosphatidyl choline fraction in tissues. This may indicate complexing of phospholipids which may enhance the bioavailability and stability of such compounds.

It is known that there exists a synergism between phospholipids and naturally occurring anti-oxidants in plants. For example, it has been demonstrated that when phospholipids are combined with naturally occurring anti-oxidants (eg. α-tocopherol and/or quercetin) there is a substantial improvement in oxidative stability. Further, synergistic phenomena have been further investigated and it has been concluded that the presence in the synergist molecule of a strongly acid proton generating function is of importance. EP 0 209 038 also discloses combinations between lipophilic complexes of various compounds with phospholipids. This reference demonstrates that the absorption of these complexes in the gastrointestinal tract is appreciably greater which results in high plasma levels than when the compounds are administered individually.

Many drugs which would make desirable combinations are chemically incompatible and thus a combination of these drugs is not possible. For example, Levamisole is stable at approximately pH3.5 and Closantel is stable at approximately pH9. Fenbendazole is a further example of an insoluble benzimadiazole, stable at approximately pH9. Other drugs suitable for use in this invention are drugs such as proton pump inhibitors such as omeprazole and its family which are unstable at acid pH and therefore are unstable in the stomach. Thus, a stable combination of these compounds would seem to be unachievable. The processes of the present invention, which will be presently described, in fact make this combination possible.

### DISCLOSURE OF THE INVENTION

The present inventors have demonstrated that it is possible to solubilise non-polar and polar components isolated from plants by adding phospholipids in the lipid phase of a one or more phasic composition and forming micelles which form multiphasic systems, do not separate into two or more phases and which are then soluble or dispersable in water. The end result of the processes of this invention which will be more fully described below, is a greatly increased bioavailability of these compounds.

Thus, in a first broad form of this invention, there are described processes which are applicable to compounds which may be soluble in either polar or non-polar solvents and compounds which are soluble only in physiologically acceptable polar or non-polar solvents. When the processes of this first broad form of the invention are applied to this class of compounds, the result is a clear or substantially clear water-soluble emulsion with an increased bioavailability and/or activity and/or stability.

A second broad form of the invention is based on the surprising finding by the present inventors that there is another class of insoluble compounds to which this invention is applicable, these being compounds which will only be effectively solubilised by solvents which are physiologically unacceptable. It has been considered until now, that it has not been possible to improve the bioavailability, activity or stability of such compounds. Examples include phytosterols and combinations of phytosterols, and benzimadiazoles such as omeprazole and combinations of benzimadiazoles. When the processes of this second broad form of the invention are applied to this class of compounds, the result is a dispersion containing the compound and where the compound has increased stability, sustained release formulation and increased bioavailability and/or activity.

Whereas in the first broad form of the invention, a solution of two phases results, in the second broad form addition of the compound to the solvent results in a paste.

A further purpose of this invention is also to make stable solutions of drugs and herbal extracts, when used in combination with other drugs. Examples particularly applicable are anthelmintics, antibiotics, natural and synthetic anti-insect drugs (for example insect growth regulators), natural and synthetic herbicides (such as essential oils) and, anti-ulcer drugs. Thus, examples of compounds encompassed by this description are flavonoids, silymarin, Ginkgo, grape seed extract, soy extract, green tea, pycnogenol, glucosamine and chondroitin sulphate and fat soluble compounds such as CoQ10, and vitamin E.

There are distinct advantages of having combinations of drugs, anthelmintics, antibiotics and anti-insect drugs, which achieves two general purposes:

1) To broaden the spectrum of activity of a single product to be effective against a wider range of parasites/pests/bacterial/fungi.

2) To present a multiple mode of action against the target species and thereby reduce the possibility or speed of onset of resistance.

The other advantage of solubilising drugs achieves the following.

3) To improve the therapeutic outcome, by improving the bioavailability, stability and requiring a lower dose, thereby being more cost effective.

With the above observations in mind therefore, the present invention is presently described.

According to a first embodiment of this invention (which is based on the first broad form of this invention), there is provided a process of preparing an emulsion of a solubilised compound, said compound being soluble in a physiologically acceptable aqueous or nonaqueous solvent, said process comprising:

(a) adding a complexing agent to at least one said solvent containing at least one said compound, the agent being capable of forming a compound:agent complex;

(b) adding an emulsifier to the solvent containing the compound and the complexing agent; and

(c) forming an emulsion.

Generally the compound:agent complex formation is complete prior to or during step (c) and the emulsion includes the formed compound:agent complex.

Generally the amount of agent added is at least sufficient to clarify substantially all of the compound in the solvent. Steps (a)-(c) are generally conducted at temperatures or within a temperature range whereby the agent, the compound and the compound:agent complex are substantially dissolved in the solvent. If a multiphasic complex of more than one solvent is used then steps (a)-(c) are generally conducted at temperatures or within a temperature range whereby the agent, the compound and the compound:agent entity are substantially dissolved in at least one of the solvents. Depending on the agent, the compound and the compound:agent complex, the compound:agent complex will form in steps (a), (b) and/or (c).

According to a particular example of the first embodiment of this invention there is provided a process of preparing an emulsion comprising:

(a) adding a phospholipid agent to a solvent containing a compound, the agent being capable of forming a compound:agent complex;

(b) adding a first emulsifier to the solvent containing the compound and the agent;

(b′) adding a second emulsifier to the solvent containing the compound and the agent and the first emulsifier; and

(c) forming the compound:agent complex and an emulsion

wherein the step of forming a compound:agent complex occurs during at least one of steps (a) to (c).

According to a second embodiment of this invention (which is based on the second broad form of this invention), there is provided a process of preparing a dispersion of a compound which is insoluble in a physiologically acceptable aqueous or nonaqueous solvent but only soluble in a physiologically unacceptable solvent, said process comprising:

(a) adding said compound to at least one physiologically acceptable solvent;

(b) adding a complexing agent to the compound plus solvent of (a);

(c) further adding an emulsifier to the compound plus solvent plus complexing agent of (b);

(d) forming a dispersion of said compound in said physiologically acceptable solvent.

According to a third embodiment of this invention there is provided an emulsion when prepared by the process of the first embodiment.

According to a fourth embodiment of this invention there is provided a dispersion when prepared by the process of the second embodiment.

According to a fifth embodiment of this invention there is provided a composition comprising the emulsion of the first embodiment or the dispersion of the second embodiment together with an acceptable adjuvant, excipient, diluent, additive and/or carrier.

According to a sixth embodiment of this invention there is provided a method of administering a compound to an animal comprising administering an emulsion of the third embodiment or a dispersion of the fourth embodiment or a composition according to the fifth embodiment to the animal.

Depending on the nature of the agent and the emulsifiers the bioavailability and/or stability of the compound or compounds in the solvent may be increased. The compound or compounds whose bioavailability and stability, it is desired to increase, may, in addition to being present as single or multiple compounds, be in the form of an animal, a plant extract, drugs, proteins, minerals, antibiotics, anthelmintics, natural and synthetic anti-insect drugs and also natural and synthetic herbicides.

The emulsion of the first to fourth embodiments typically comprises micelles. Typically the emulsion is substantially clear or is clear. Generally the substantially clear or clear emulsion of the invention may be added in an amount up to 5% v/v to water (typically up to 0.5% v/v, 0.75% v/v, 1% v/v, 1.25% v/v, 1.5% v/v, 2% v/v, 2.5% v/v, 3% v/v, 3.5% v/v, 4% v/v or 4.5% v/v) and the resultant mixture remains substantially clear or clear or opalescent.

The solvent may be a suitable polar solvent present as a single solvent or mixture of various solvents or a multiphasic mixture of two or more immiscible or substantially immiscible phases (eg. a polar phase/non-polar phase multiphasic entity such as eg. a water/oil or glycol/oil multiphasic entity).

It is preferred that when the polar phase is either a monophasic solution or is part of a multiphasic entity, an alkanol such as ethanol, propanol, or polyvinyl alcohol; lower alkanols, for example isopropanol; acetone; lower aralkanols; a glycol such as lower polyalkylene glycols or lower alkylene glycols, for example polyethylene glycol, polypropylene glycol, ethylene glycol, 1,3-butylene glycol propylene glycol; glycerol; a pyrrolidone such as polyvinylpyrrolidone, methylpyrrolidone or 2-pyrrolidone; vinegar, water etc., (typically a polar solvent which is non-toxic and complies with the appropriate food or pharmaceutical code when the emulsion is required to be taken orally by a human or animal), or a combination of any two or more of the above. Further examples of polar solvents are hydroxy compounds such as n-butanol, sec-butanol, pentanol, cyclohexanol, hexanol, heptanol, 2-octanol, diacetone alcohol, polyvinyl alcohol, 2-ethyl-hexanol, benzyl alcohol, phenol, allyl alcohol, 2-ethyl-1,3-hexanediol, bis(2-butoxyethyl) ether, butoxyethoxypropanol, hexylene glycol, ethylene glycol monobutyl ether, ethylene glycol monomethyl ether, ethylene glycol monoethyl ether, diethylene glycol, ethyl ether, propyl ether; carbonyls such as 4-hydroxy-4-methyl-2-pentanone, cyclopentanone, cyclohexanone, 2-butanone, 3-pentanone, 2-hexanone, propyl acetate, ethyl acetate, butyl cellosolve acetate, 2-(2-ethoxyethoxy)-ethanol acetate, acetic acid, ethyl malonate, butaraldehyde; nitrogen compounds such as acetonitrile, propionitrile, trimethylamine, triethylamine, dimethylformamide, propylamine, dimethylethanolamine, diisopropanolamine, monoethanolamine, 2-amino-2-methyl-1-propanol, N-ethylpyrrolidone, N-octylpyrrolidone, N-methylpyrrolidone, N-butylpyrrolidone, N-isooctylpyrrolidone, 1-methyl-2-pyrrolidone, N-dodecylpyrrolidone, or other alkyl pyrrolidone of the formula:

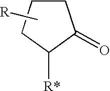

where R is H or a linear or branched alkyl having from 1-12 carbon atoms, and R* is a linear or branched alkyl having from 1-12 carbon atoms other solvents such as 2-butoxyethanol, 2-(2-methoxyethoxy)ethanol or 2-methoxyethanol. Further examples of water soluble/miscible solvents are described in “Industrial Water-Based Paint Formulations”, Ernest W Flick, Noyes Publications, 1988, the contents of which are incorporated herein by cross reference.

The non polar (nonaqueous) phase may be any substance that is not substantially miscible with the polar phase. It can be any vegetable, animal or mineral oil such as coconut oil, peanut oil, olive oil, rapeseed oil, soybean oil, safflower oil, olive oil, cottonseed oil, maize oil, sesame oil, arachis oil, palm oil, fish oil such as tuna, mackerel, sand eel, menhaden, anchovy, sardine, horse mackerel, salmon, herring, cod, capelin, pilchard, sprat, whale oil, Pacific oyster, Norway pout, seal oil, or sperm whale oil, paraffin oil, a water immiscible organic solvent (typically an organic solvent or oil which is non-toxic and complies with the appropriate food or pharmaceutical code when the emulsion is required to be taken orally by a human or animal), a triglyceride or a fatty acid or a solvent which is non toxic and complies with the appropriate food or pharmaceutical code when the emulsion is required to be taken orally by a human or animal or a mixture of any two or more of the above. Another class of solvents which are not water soluble but are good solubilisers are the monoterpenes which are found in the essential oils of many plants. The main monoterpene of interest in this invention is D-Limonene and is a good transdermal carrier of drugs across membranes including the gut mucosal membrane. D-Limonene is a good solvent for solubilising water insoluble drugs which are soluble in a hydrophobic environment. The preferable non-polar (nonaqueous) phase is dependent upon the required pharmacokinetics. For example, medium chain triglycerides (C₄-C₁₂), more typically (C₈-C₁₂) (eg. Delios V by Henkel) are absorbed via the portal system and metabolised by the liver in 30-40 minutes, while long chain fatty acids C₁₆ and greater are carried via chylomicrons and therefore take much longer to be metabolised. Therefore depending on the carbon chain length it can be a slow release or sustained release drug or fast and rapidly metabolised drug. Medium chain triglycerides are absorbed into the portal system and metabolised by the liver rather than long chain fatty acids, which are carried via chylomicrons and are transported to the thoracic duct. Further examples of water soluble/miscible and non-polar water immiscible solvents are described in “Organic Solvents Physical Properties and Methods of Purification”, John A. Riddick, William B. Bunger and Theodore K. Sakano, fourth edition, Volume II, John Wiley & Sons 1986, and “Chemical Safety Data Sheets”, David Walsh (editor), Volume I, The Royal Society of Chemistry 1989.

The complexing agent is typically a phospholipid or an organic phosphate such as creatine phosphate, any sugar phosphate, AMP, or ADP; or other complexing agents such as choline esters, succinates, amino esters, amino acetates, cysteine, homocysteine, glutathione, or acetylcysteine.

Advantageously, the phospholipid is a naturally occurring or synthetic phospholipid which may be of animal or vegetable origin or may be synthetic, with acyl residues being the same or different. For example a typical phospholipid useful in this invention has the following formula:

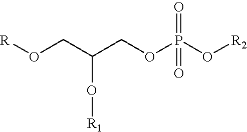

wherein R and R₁ are the same or different and are preferably palmitic, stearic, oleic, linoleic, or linolenic acids while R₂ is preferably choline, ethanolamine or serine.

The natural or synthetic phospholipids used in preparation of the formulation may be for example, lecithins from vegetable origin (for example soya phospholipids such as Lipoid S100 From Lipoid KG-Ludwigshafen, Germany) or egg yolk phospholipid or natural phospholipids extracted from liver, phosphatidylcholine, phosphatidylethanolamine, phosphatidylinositol, 1:2-dipalmitoyl-sn-glycerol-3-phosphoethanol-amine, 1:2-dipalmitoyl-sn-glycerol-3-phosphoethanolcholine, or phosphatidylserine. Other phopholipids may be obtained from Lucas Meyer West Germany such as those known by the trade name of Metarin P. The phospholipid used is generally soluble in the non-polar phase (eg. it is soluble in the organic phase such as in medium or long chain triglycerides or in oil) when the temperature is from 30-95° C., typically 35-90° C., more typically 40-85° C., more typically 45-80° C., and more typically 50-70° C. (depending on its nature and properties if another complexing agent is used in place of a phospholipid, it may be soluble and complex in the polar phase and/or the non polar phase at room temperature and/or elevated temperatures such as the temperature ranges disclosed above). Phospholipids are more soluble in medium chain triglycerides (typically up to 30 wt %), while in long chain triglycerides are typically about 10 wt % soluble. The preferred concentration for this invention is 25 wt % phospholipid in medium chain triglycerides, ending up with 5 wt % phospholipids in the final solution.

The emulsifier is typically a combination of emulsifiers depending upon the particular herb, drug, vitamin or mineral of interest. The combination of emulsifiers may comprise 2, 3, 4, 5, 6, 7, 8, 9, 10 or more different emulsifiers. Such emulsifiers may be polyoxyethylene stearates (e.g. polyoxyethylene(40) stearate), polyoxyethylene oleates, polyoxyethylene laurates, polyoxyethylene caster oil derivatives, sorbitan esters, polyoxyethylene sorbitan fatty acid esters. Polysorbate 60 in combination with cremophor EL or cremophor RH40 is particularly suitable. The ratio of polysorbate to cremophor is typically 25:75 wt:wt. The total amount of emulsifier in the completed mixture can be anywhere between 1 to 99 wt %. The preferred concentration is 15-50 wt %, more typically 2045 wt %, more typically 2543 wt %, even more typically 30-40 wt % in order to get a suitable concentration of active in the mixture and still have a flowing solution without a gel being formed. Typically at least two emulsifiers are used and the first emulsifier:second emulsifier eg. polysorbate 20-85(typically 60):cremophor (or e.g. polysorbate 2081:polysorbate 85) are used as the emulsifiers in a ratio 1:99 wt:wt to 99:1 wt:wt more typically 10:90 wt:wt to 90:10 wt:wt, more typically 5:95 wt:wt to 40:60 wt:wt, even more typically 15:85 wt:wt to 30:70 wt:wt, more typically 25:75 wt:wt. Examples of the first and second emulsifiers are given in the table below:

First Emulsifier:Second Emulsifier = 99:1 wt:wt to 1:99 wt:wt*

| First Emulsifier | Second Emulsifier |
|---|---|
| (a) Polyoxyethylene sorbitan | (a′) Polyethoxylated |
| esters particularly polysorbate | triglycerides including |
| 20-85 such as polysorbate 20, | polyethoxylated vegetable |
| polysorbate 40, polysorbate 60, | oil (including Emulphor |
| polysorbate 65, polysorbate 70, | EL-719 and Emulphor EL- |
| polysorbate 80, polysorbate 81, | 620), polyethoxylated |
| and polysorbate 85, polyoxy- | castor oil including |
| ethylene stearates including | polyoxyl 35 caster oil, |
| polyoxyethylene (8) stearate | polyoxyl 40 hydrogenated |
| and polyoxyethylene (40) | caster oil, polyoxyethylene |
| stearate, polyoxyethylene | (40-60 including 40 and 60) |
| oleates, polyoxyethylene | castor oil derivatives |
| laurates, polyglycerol | (including cremophor EL, |
| esters of fatty acids | cremophor RH40, cremophor |
| including polyglycol | RH410, cremophor RH455, and |
| polyricinoleate, or | cremophor RH60) or mixtures |
| mixtures thereof | thereof |
| (b) Polysorbate 20-81 such | (b′) Polysorbate 85 |
| as polysorbate 20, poly- | |
| sorbate 40, polysorbate | |
| 60, polysorbate 65, poly- | |
| sorbate 70, polysorbate | |
| 80 and polysorbate 81, | |
| polyoxyethylene | |
| stearates including | |
| polyoxyethylene (8) | |
| stearate and polyoxy- | |
| ethylene (40) stearate, | |
| polyoxyethylene oleates, | |
| polyglycerol esters of | |
| fatty acids including | |
| polyglycerol | |
| polyricinoleate, | |
| polyoxyethylene laurates, | |
| or mixtures thereof | |

The amounts of the first and second emulsifiers, and the ratio of the first emulsifier to the second emulsifier are typically chosen so that the resultant emulsion is substantially clear.

The emulsion which is produced by the process of this invention may be in form of micelles which contain the compound or compounds whose bioavailability it is desired to increase or an entity between that compound or compounds, phospholipid and emulsifying agent.

When the agent is a phospholipid, it is typically solubilised in the nonaqueous phase and the partitioned fractions are made insoluble with a series of emulsifiers to make stable micelles in which the phospholipids combine with the compound of interest e.g. various plant components in the case of a plant extract. In the case of an emulsified plant extract, for example, the final emulsion may be soluble in water. The weight ratio of phospholipid to active in the plant extract is typically from 0.25:1 to 5:1, more typically 0.5:1 to 2:1 even more typically 1:1 (especially for herbs) depending on solubility and concentration. For minerals, vitamins, peptides, antibiotics, anthelmintics, insect growth regulators and other anti-insect drugs the weight ratio of phospholipid to active is typically in the range 0.01:1 to 2:1.

In practice, the extract containing the compound or compounds of interest is mixed with either a monophasic solution or is partitioned in a multiphasic composition, followed by the addition of complexing agent, in which case it is necessary to partition the compound or compounds of interest prior to addition of the agent. The reaction conditions are dictated by the compound or compounds of interest.

For example, partitioning may be brought about by agitation in a multiphasic composition, the agitation being either ultrasonic, mechanical or by shaking.

The temperature range is dependent upon the type of phospholipid and the solubility of that phospholipid in the non-aqueous media. The temperature should not be higher than the stability of the compound in question.

Emulsifiers are added to the biphasic mixture as a whole, the mixture homogenised and phospholipid:compound entities are formed into an emulsion (and/or micelles) as a result. The temperature range for forming the emulsion is typically from about 20° C. and about 95° C., more typically 25-95° C., more typically 30-95° C., more typically 35-90° C., more typically 40-85° C., more typically 45-80° C., more typically 50-70° C., more typically 20-70° C. A substantially clear or clear emulsion is formed. The emulsion stays clear on cooling to room temperature. The emulsion does not separate into two layers on cooling to room temperature. Addition of emulsion to water in an amount of emulsion:water 0.5-5:100-1 v:v results in a substantially clear or clear or opalescent solution or mixture.

Depending on the compound combined with phospholipid according to the above methods, the resultant emulsion may be mixed with edibly, pharmaceutically and/or cosmetically acceptable adjuvants, excipients, diluents, additives and/or carriers. For example, the emulsion/composition of the present invention may be administered orally, parenterally, rectally, topically, vaginally, or conjunctivally or as a topical spray containing conventional, non-toxic, pharmaceutically acceptable carriers, diluents, additives and/or excipients as desired. The emulsion/composition of the present invention may be incorporated with a liquid, semi-solid (such as a gel or paste) or solid, liquid or semi solid foodstuff.

Liquid dosage forms for oral administration may include pharmaceutically acceptable (or veterinarilly acceptable where the dosage form is intended for animals) in the case of acceptable emulsions, syrups, solutions, suspensions, and elixirs containing inert diluents commonly used in the art, such as water. Such compositions may also comprise wetting agents, emulsifying and suspending agents, and sweetening, flavouring, and perfuming agents including sugars such as sucrose, sorbitol, fructose etc, glycols such as polyethylene glycol, propylene glycol etc, oils such as sesame oil, olive oil, soybean oil etc, antiseptics such as alkylparahydroxybenzoate etc, and flavours such as strawberry flavour, peppermint etc.

The topical composition may also be present as a paste in which case a preferred thickening agent is carbopol or equivalent thickening agents and preferred preservatives are sodium propyl hydroxybenzoate or methyl paraben and propyl paraben.

Solid dosage forms for oral administration may include capsules. In such forms, the emulsion may be admixed with at least one inert diluent such as silicas, dicalcium phosphate, sugars, talcs. In the case of capsules, the dosage forms may also comprise buffering agents. The capsules can additionally be prepared with enteric coatings.

Parenteral as used herein includes subcutaneous injections, intravenous, or intramuscular injection, or infusion techniques.

When present as an injectable preparation, for example, sterile injectable aqueous or oleagenous suspensions may be formulated according to the known art using suitable dispersing or wetting agents and suspending agents. The sterile injectable preparation may also be a sterile injectable solution or suspension in a non-toxic parenterally acceptable diluent or solvent, for example, as a solution in 1,3-butanediol. Among the acceptable vehicles and solvents that may be employed are water, Ringer's solution, and isotonic sodium chloride solution. In addition, sterile, fixed oils are conventionally employed as a solvent or suspending medium. For this purpose any bland fixed oil may be employed including synthetic mono- or diglycerides. In addition, fatty acids such as oleic acid find use in the preparation of injectables.

The compositions can be prepared as suppositories for rectal administration by mixing the composition with a suitable non-irritating excipient such as cocoa butter, paraffins, lanolins and polyethylene glycols which are solid at ordinary temperatures but liquid at the rectal temperature and will therefore melt in the rectum and release the drug.

The process of the present invention is especially applicable to compounds which are insoluble in a phase in which it is desirable that such compounds are used, for example, in pharmaceutical or cosmetic preparations. For instance, it may be desirable to use a compound or compounds in an aqueous phase where normally such compound or compounds are insoluble. Alternatively, it may be desirable to use a compound or compounds in a non-aqueous phase, the compound or compounds being insoluble in such a phase. The process of the first embodiment is also applicable to compounds that are soluble in the (aqueous and/or organic) solvent(s).

The processes of the present invention are applicable to synthetic drugs, plant and animal compounds plant flavonoids which comprises various subclasses such as flavans, flavanones, flavones, anthocyanins etc. Flavonoids may be monomeric, dimeric, oligomeric and may also exist in free or glycosidic forms phytoestrogens from soy or red clover, Curcuminoids from tumeric, berberine from the genera Berberis, Flavanolignans from silymarin, and animal compounds such as glucosamine and chondroitin sulphate and hydrophobic synthetic drugs, natural compounds from plants and animals such as carotenoids, lycopene, lutein, tocopherols, phytosterols and waxes such as policosanols.

The process of the present invention is also applicable to emulsifying compounds such as peptides and proteins, where it is desirable to protect such proteins and peptides from digestion in the gastrointestinal tract. Examples are insulin, erythropoietin, calcitonin, LHRH (lutinizing hormone releasing hormone), prolactin, interleukins, somatostatin, interferon, gastrin, and vasopressin. Typically the Protein or peptide can have a molecular weight of greater than 1000.

Also the administration of proteins/peptides in colloidal vehicles eg. lysosomes, emulsions, might lead to an enhancement of the presentation of the material to lymphoid tissue, resulting in adjuvant properties of these types of formulations and exploiting these properties in the development of vaccines.

Emulsions of proteins/peptides in accordance with the invention are more potentially stable over a large pH range and are more absorbable over this pH range.

The process of the present invention is also applicable to the emulsification of minerals and/or mineral extracts. For example, the absorption of inorganic minerals particularly vanadium, chromium, cobalt, molybdenum, zinc is extremely poor, for example vanadium 0-1% chromium 1-3%. The absorbability of chromium as a natural complex can be increased from 3% to 25%. There is evidence that vanadium improves hepatic and peripheral insulin sensitivity in patients with non-insulin-dependent diabetes. The problem with vanadium is that the therapeutic dose is very close to the toxic dose. Various ligands have been attached to vanadium to make the molecule more hydrophobic, and hence could be emulsified to change the bioavailability and hence change the narrow window of therapeutic and toxic dose. Homogenisation by stirring and/or blending can take place at various speeds depending on the compounds being emulsified, For example, speeds of 200-20000 rpm typically 500, are generally used but for water emulsions 20000 rpm can be used.

Cobalt, chromium and molybdenum salts are usually taken up in ruminants by the ruminant ecology. Emulsions of these organic entities could protect from ruminant digestion and hence make the mineral more available for the animals requirements. Similar situation in man where cobalt as vitamin B12 is poorly absorbed unless the intrinsic factor is present. The emulsion of cobalt may be a process of absorbing cobalt.

The process of the present invention is also applicable to the emulsification of other non-polar components isolated from plants, for example, phytosterols, fatty acids, triglycerides, carotenoids lutein, β tocopherols, tocotrienols, lycopenes, and coenzyme Q. In addition, we demonstrated that plant terpenes combined with phytosterols and phospholipids increase absorption and the non polar portion of the plant material.

The process of the present invention is also applicable to the emulsification pharmaceutically and veterinary active compounds including antibacterial and antifungal compounds. For instance, vancomycin is poorly absorbed by mouth and hence is used as an injectable. As an emulsion the bioavailability is dramatically improved and can be administered orally. Also, amphotericin absorption can also be improved and also its toxicity.

The emulsions prepared by this invention can also change the pharmacokinetics of drugs as well as acid unstable drugs eg, Rifampicin has a prolonged release into plasma following oral administration of a oil/water emulsion. Using the processes of this invention provides an effective method of protecting the omeprazole family from breaking down in the stomach.

A surprising and extremely beneficial feature of the processes of this invention whether in the first broad form or second broad form outlined above, allows the bioavailability of a compound to be controlled. Thus, it is possible using conditions which will be described below, to choose the degree of bioavailability of a compound.

### BRIEF DESCRIPTION OF THE DRAWINGS

FIG. 1 is a graphic representation of plasma levamisole concentration;

FIG. 2 is a graphic representation of plasma closantel;

FIG. 3 is a representation of the stability of various formulations of omeprazole in 0.01N HCl;

FIG. 4 is a graphic representation of the stability of omeprazole paste at 40° C.; and

FIG. 5 is a graphic representation of dissolution characteristics of phytosterols.

### BEST MODES AND OTHER MODES FOR CARRYING OUT THE INVENTION

When it is desirable to partition the flavonoids from Ginkgo biloba extract for example, propylene glycol and Gingko biloba are mixed and heated to 70-80° C. and maintained within that temperature range. The amount of Gingko biloba added depends upon the final concentration required. For example. 100 mg/mL would require a ratio of 1:5 wt:wt of Ginkgo biloba to propylene glycol and medium chain triglycerides mixture. The Ginkgo biloba is then partitioned, typically by stirring at 200 rpm and heating to 50-80° C. until the mixture is dissolved, if there is insoluble material left then the solution is filtered.

Medium chain triglycerides and Metarin P are mixed separately and heated to 70-80° C. and maintained within that temperature range. The ratio of propylene glycol to medium chain triglycerides is preferably of 1:1 wt:wt (for various herbs depending on their solubility for either the propylene glycol or the medium chain triglycerides the ratio can be between 1:10 wt:wt and 10:1 wt:wt). Ginkgo biloba is then added depending upon the final concentration required eg. 100 mg/mL would require a ratio of 1:5 wt:wt of Ginkgo biloba to propylene glycol and medium chain triglycerides mixture.

The complexing agent, in this case, Metarin P is added to this mixture in the weight ratio of agent/ginkgo biloba/solvent 1:2:9. In the case of other phospholipids the ranges used are phosphatidyl choline 18-26 wt %; phosphatidyl ethanolamine 10-18 wt %; phosphatidyl inositol 8-14 wt %. The mixture is maintained at or heated again to 50-80° C. typically about 60° C. The resulting complex is micellised by the addition of the combination emulsifier polysorbate 60 and cremophor EL (ratio 25:75 wt:wt) at 35-80° C. followed by medium to high speed stirring until the mixture is homogenous and forms a substantially clear emulsion. The total amount of the two emulsifiers added to the mixture is 25-40:75-60 wt:wt. A substantially clear or clear emulsion is formed. The emulsion stays clear on cooling to room temperature. The emulsion does not separate into two layers on cooling to room temperature. Addition of emulsion to water in an amount of emulsion:water 0.5-5:100 v:v results in a substantially clear or clear or opalescent solution or mixture.

The present invention will now be described with reference to the following examples which should not be construed as limiting on the scope thereof.

### EXAMPLE 1

22.5 g propylene glycol and 10 g of gingko biloba were mixed and heated to 70-80° C. and maintained within that temperature range. 22.5 g of medium chain triglycerides and 5 g of Metarin P as complexing agent were mixed separately and heated to 70-80° C. and maintained within that temperature range. Both mixtures were then combined to form a cloudy mixture which was maintained at 70-80° C. to form ginkgo biloba:agent complex. The complex was micellised by the addition of 10 g of polysorbate 60 and 30 g of cremophor EL or 40 g of cremophor EL which was rapidly stirred without air bubble introduction (eg. by placing a stirrer at the bottom of the solution) with a stirrer/blender until homogenous, thereby forming a substantially clear solution with increased bioavailablity (see FIG. 1).

### EXAMPLE 2

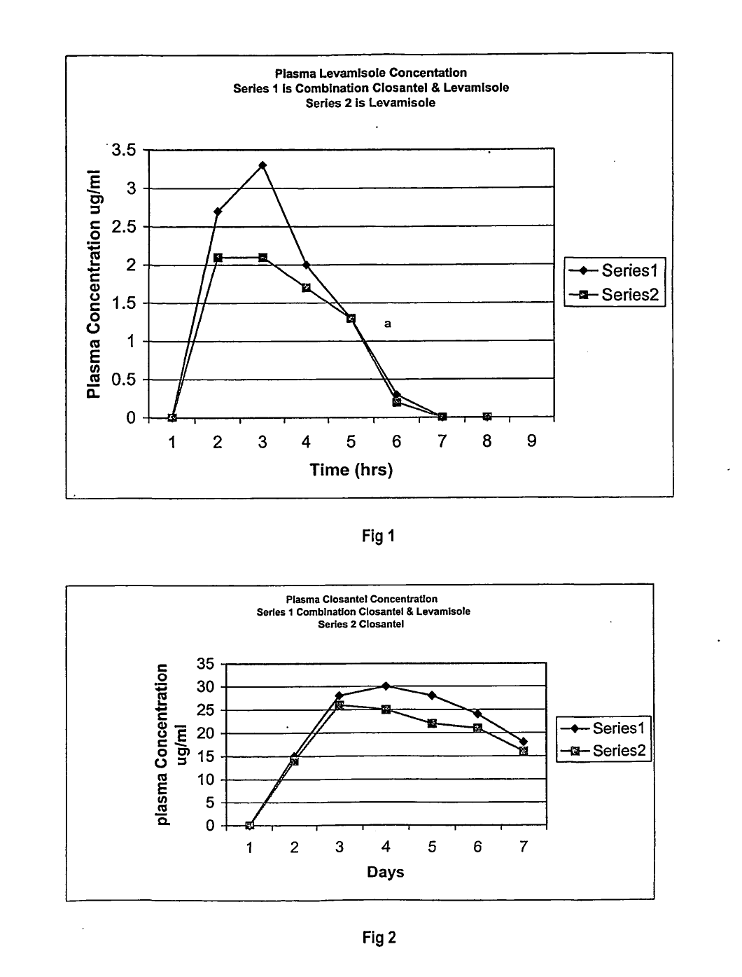

15 g propylene glycol and 10 g of silymarin (silymarin 70:1 80-88% silybin, Indena SPA Milan) were mixed and heated to 70-80° C. and maintained within temperature range. 15 g of medium chain triglycerides and 5 g of Metarin P as complexing agent were mixed separately and heated to 70-80° C. and maintained within that temperature range. Both mixtures were then combined to form a cloudy mixture which was maintained at 70-80° C. to form silymarin:agent complex. The complex was micellised by the addition of 20 g of polysorbate 60 and 35 g of cremophor EL which was rapidly stirred without air bubble introduction (eg. by placing a stirrer at the bottom of the solution) with a stirrer/blender until homogenous, thereby forming a substantially clear solution and also an increase in bioavailablity (See FIG. 2).

### EXAMPLE 3

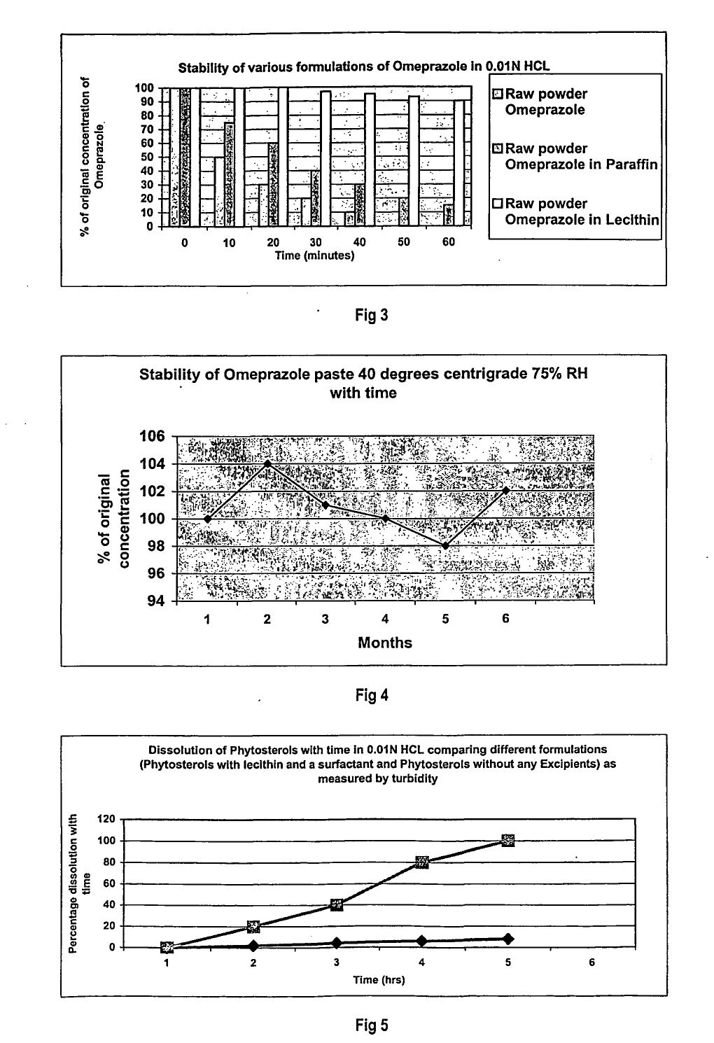

30.8 g of a α-d-tocopherol (1.30 IU/mg), 5 g medium chain triglycerides and 5 g liquid lecithin as the complexing agent. 25.7 g of polysorbate 80 and 25 g Cremophor EL was slowly added and mixed, while stirring 7.5 g of propylene glycol was added along with 1 g of mixed tocopherols and rapidly stirred with a stirrer/blender until homogenous, thereby forming a substantially clear solution with again an increased bioavailability (see FIG. 3).

### EXAMPLE 4

8.33 g of a ubiquinone (coenzyme Q10) was added to 15.8 g medium chain triglycerides and 4 g Metarin P as the complexing agent. This mixture was heated to 70° C. 13.8 g propylene glycol was then added to form a ubiquinone:agent complex. The complex was micellised 58.07 g of cremophor and rapidly stirred with a stirrer/blender until homogenous.

### EXAMPLE 5

22.5 g propylene glycol and 10 g of grape seed (vitis vinifera 120:1 Indena SPA Milan) were mixed and heated to 70-80° C. and maintained within temperature range. 22.5 g of medium chain triglycerides and 5 g of Metarin P as complexing agent were added and heated to 70-80° C. and maintained within that temperature range. Both mixtures were then combined to form a cloudy mixture which was maintained at 70-80° C. to form grape seed-active agent:complex. The complex was micellised by the addition of 10 g of polysorbate 60 and 30 g of cremophor EL and rapidly stirred without air bubble introduction (eg. by placing a stirrer at the bottom of the solution) with a stirrer/blender until homogenous, thereby forming a substantially clear solution.

### EXAMPLE 6

22.5 g propylene glycol and 10 g of Soy extract were mixed and heated to 70-80° C. and maintained within temperature range. 22.5 g of medium chain triglycerides and 5 g of Metarin P as complexing agent were added and heated to 70-80° C. and maintained within that temperature range. Both mixtures were then combined to form a cloudy mixture which was maintained at 70-80° C. to form grape seed-active agent:complex. The complex was micellised by the addition of 10 g of polysorbate 60 and 30 g of cremophor EL and rapidly stirred without air bubble introduction (eg. by placing a stirrer at the bottom of the solution) with a stirrer/blender until homogenous, thereby forming a substantially clear solution.

### EXAMPLE 7

22.5 g propylene glycol and 10 g of green tea extract were mixed and heated to 70-80° C. and maintained within temperature range. 22.5 g of medium chain triglycerides and 5 g of Metarin P as complexing agent were added and heated to 70-80° C. and maintained within that temperature range. Both mixtures were then combined to form a cloudy mixture which was maintained at 70-80° C. to form grape seed-active agent:complex. The complex was micellised by the addition of 10 g of polysorbate 60 and 30 g of cremophor EL and rapidly stirred without air bubble introduction (eg. by placing a stirrer at the bottom of the solution) with a stirrer/blender until homogenous, thereby forming a substantially clear solution

### EXAMPLE 8

22.5 g propylene glycol and 10 g of Pycnogenol extract were mixed and heated to 70-80° C. and maintained within temperature range. 22.5 g of medium chain triglycerides and 5 g of Metarin P as complexing agent were added and heated to 70-80° C. and maintained within that temperature range. Both mixtures were then combined to form a cloudy mixture which was maintained at 70-80° C. to form grape seed-active agent:complex. The complex was micellised by the addition of 10 g of polysorbate 60 and 30 g of cremophor EL and rapidly stirred without air bubble introduction (eg. by placing a stirrer at the bottom of the solution) with a stirrer/blender until homogenous, thereby forming a substantially clear solution

### EXAMPLE 9

30 g water, 1 g glucosamine and 1 g of chondroitin sulphate were mixed and heated to 50° C. and the temperature maintained. 10 g of medium chain triglycerides and 5 g of lecithin as complexing agent were added and heated to 40° C. and maintained within that temperature range. Both mixtures were then combined to form a cloudy mixture which was maintained at 40° C. to form the active agent:complex.

### EXAMPLE 10

50 g water, 300 mg glucosamine hydrochloride and 2 g chondroitin sulphate were mixed. To this was added 2 g excipient (thickening agent, eg. Carbopol) and heated to 50° C. and dissolved. 45 mL ethanol and 1 g d-limonene were then added and the pH adjusted to 6 with NaOH. The complex was miscellised by the addition of 1 g polysorbate 80 or 1 g cremophor EL and rapidly stirred without air bubble introduction (e.g. by placing a stirrer at the bottom of the solution) with a stirrer/blender until homogenous, thereby forming a substantially clear solution.

### EXAMPLE 11

Transdermal Formulation

| Formulation for 100 g of gel: | | |
|---|---|---|
| Complex preparation (as in Examples 1-10). | 50 | g |
| Triethanolamine | 1 | g |
| Carboxyvinyl polymer (carbopol 934^{R}) | 1.5 | g |
| Perfume | 0.1 | g |
| Sodium hydroxybenzoate | 0.2 | g |
| Isopropylmyristate | 1.0 | g |
| d-limonene | 0.5 | g |
| Distilled water qs to | 100 | g |

### EXAMPLE 12

Minerals

Molybdenum

40 mg of sodium molybdate, equivalent to 18.6 mg of elemental molybdate (or an equivalent organic salt) was dissolved in 10 g of propylene glycol. 5 g of Metarin P was dissolved by heating to 70° C. in 10 g of medium chain triglycerides. The two solutions were micellised by the addition of 10 g of polysorbate 60 and 30 g cremophor EL and rapidly stirred without air bubble introduction (eg. by placing a stirrer at the bottom of the solution) with a stirrer/blender until homogenous.

Vanadium

5 g of sodium vanadate, equivalent to 2.1 g of elemental vanadate (or the equivalent of organic vanadate) was dissolved 30 g of propylene glycol. 5 g of Metarin P was dissolved by heating to 70° C. in 30 g of medium chain triglycerides. The two solutions were micellised by the addition of 10 g of polysorbate 60 and 30 g cremophor EL and rapidly stirred without air bubble introduction (eg. by placing a stirrer at the bottom of the solution) with a stirrer/blender until homogenous.

Cobalt

3 mg of cobaltic acetate, equivalent to 0.72 g of elemental cobalt (or the equivalent or organic cobalt) was dissolved 10 g of propylene glycol. 5 g of Metarin P was dissolved by heating 70° C. in 10 g of medium chain triglycerides. The two solutions were micellised by the addition of 10 g of polysorbate 60 and 30 g cremophor EL and rapidly stirred without air bubble introduction (eg. by placing a stirrer at the bottom of the solution) with a stirrer/blender until homogenous.

Chromium

6 mg of chromic acetate equivalent to 1.32 mg of elemental chromium (or the equivalent of organic chromium) was dissolved 10 g of propylene glycol. 5 g of Metarin P was dissolved by heating to 70° C. in 10 g of medium chain triglycerides. The two solutions were micellised by the addition of 10 g of polysorbate 60 and 30 g cremophor EL and rapidly stirred without air bubble introduction (eg. by placing a stirrer at the bottom of the solution) with a stirrer/blender until homogenous.

### EXAMPLE 13

Peptides

Insulin 28 IU/g was used. 200 mg of insulin was added to 30 g of ethanol, pH was adjusted to 4 to dissolve the insulin then once dissolved the pH is adjusted to 7.4. 5 g liquid lecithin was dissolved in 30 g of medium chain triglycerides. The two mixtures were micellised by the addition of 10 g of polysorbate 60 and 30 g of cremophor EL and rapidly stirred without air bubble introduction (eg. by placing a stirrer at the bottom of the solution) with a stirrer/blender until homogenous.

### EXAMPLE 14

Antibiotics

Vancomycin

6 g of vancomycin was dissolved in 10 g glycerol and 10 g ethanol by adjusting the pH to 4.5. 5 g Metarin P was dissolved in 30 g of medium chain triglycerides by heating to 60° C. The two mixtures were added together and 10 g of polysorbate 60 and 30 g cremophor EL and rapidly stirred without air bubble introduction (eg. by placing a stirrer at the bottom of the solution) with a stirrer/blender until homogenous.

Amoxycillin

5 g of amoxycillin trihydrate was dissolved in 30 g 2-pyrrolidone or 20 g of NMP. 5 g Metarin P was dissolved in 30 g of medium chain triglycerides by heating to 60° C. The two mixtures were added together and 10 g of polysorbate 60 and 30 g cremophor EL and rapidly stirred without air bubble introduction (eg. by placing a stirrer at the bottom of the solution) with a stirrer/blender until homogenous.

Amoxyciilin and Clavulanic Acid

5 g of amoxycillin trihydrate and 1.25 g clavulanic acid (as potassium clavulanate) was dissolved in 30 g 2-pyrrolidone. 5 g Metarin P was dissolved in 30 g of medium chain triglycerides by heating to 60° C. The two mixtures were added together and 10 g of polysorbate 60 and 30 g cremophor EL and rapidly stirred without air bubble introduction (eg. by placing a stirrer at the bottom of the solution) with a stirrer/blender until homogenous.

### EXAMPLE 15

Anthelmintics

3.2 g of levamisole was dissolved in 15 g of propylene glycol or isopropyl alcohol by heating to 50° C. 3.75 g closantel was dissolved by heating to 50° C. in 2-pyrrolidone. 3 g of Lecithin was added to 20 g of medium chain triglycerides.

The three mixtures were added together and the complex was micellised by the addition of 60 g of cremophor EL and rapidly stirred, maintaining the temperature at 60° C. with a stirrer/blender until homogenous.

Plasma Concentrations of the Closantel and Levamisole Combination Versus Commercial Closantel and Levamisole

Sheep were dosed orally with levamisole 2.5 mL/10 kg body weight (concentration 32 g/L levamisole hydrochloride). Plasma samples were taken at 0, 1, 2, 4, 6, 12, 24 h after administration. Samples were analysed for levamisole.

Another batch of sheep were dosed with closantel 1 mL/5 kg body weight (concentration 37.5 g/L closantel). Plasma samples were taken at 0, 8, 24, 48, 96 h day 7 and day 14 after administration. Samples were analysed for closantel.

The third batch of sheep were given the same dose of levamisole and closantel as a combination (combination is described in example 14). Plasma samples were taken as described above for levamisole and closantel and are shown in FIGS. 1 and 2.

Stability of Closantel and Levamisole Combination at 30° C.

The mixture as described in example 12 was tested for stability by incubating at 30° C. for a period of 12 months. The mixture was analysed by HPLC at times zero, 3 and 12 months.

| | 0 months | 3 months | 12 months |
|---|---|---|---|
| closantel | 3.75 g % | 3.72 g % | 3.69 g % |
| levamisole | 3.21 g % | 3.19 g % | 3.17 g % |

### EXAMPLE 16

Combination of Closantel, Levamisole and a Benzimadazole

3.2 g of levamisole was dissolved in 15 g of propylene glycol or isopropyl alcohol by heating to 50° C. 3.75 g of closantel was dissolved by heating to 50° C. in 20 g of 2-pyrrolidone. 2 g of fenbendazole was added to 20 g of NMP and also heated to 70° C. 2.2 g of lecithin was added to 40 g of medium chain triglycerides and added to the above mixture and the temperature maintained at that temperature.

The four solutions were added together and the complex was micellised by the addition of 609 of cremophor EL and rapidly stirred, maintaining the temperature at 60° C. with a stirrer/blender until homogenous.

Transdermal Applications

For a topical application in animals, eg. sheep, cattle, humans—to the above mixture add 1-10% d-Limonene and 1-10% isopropyl myristate.

### EXAMPLE 17

Insect Growth Regulators

Methoprene

200 g of methoprene was added to 100 g of cremophor EL, and 5 g of Lecithin was also added and the mixture was heated to 60° C. 500 g of water was also heated to 60° C., and the two mixtures were added together and homogenised and cooled.

Stability of Methoprene Formulation at 30° C.

The mixture as described in example 18 was tested for stability by incubating at 30° C. for a period of 12 months. The mixture was analysed by HPLC at times zero, 6 and 12 months.

| 0 months | 6 months | 12 months |
|---|---|---|
| 20.0 g % | 19.8 g % | 19.7% |

### EXAMPLE 18

Herbicide

100 g of pine oil or concentrate was added to 20 g of cremophor EL, and 5 g of lecithin was also added and the mixture was heated to 40° C. 800 g of water was also heated to 60° C., and the two mixtures were added together and homogenised and cooled

### EXAMPLE 19

Insect Growth Regulators: Neem

2 g of neem oil was added to 10 g medium chain triglycerides to which 1 g of liquid lecithin is added and mixed. 10 g of propylene glycol was added and the mixture emulsified by adding 40 g of cremophor EL as well as 1 g of mixed tocopherols. This mixture was diluted for insect treatment as required ranging from 1-100 ppm.

### EXAMPLE 20

Solid Dose forms

Phytosterol Base Formulation

7.3 kg of Soy phytosterols (95% pure) were added to 18.3 kg liquid lecithin, and 0.73 kg polysorbate 80 or 0.73 kg cremophor EL was added and 0.145 kg fumed silica was then added. This phytosterol base became the base for the following formulations set out in examples 21 to 27.

FIG. 5 is a graphic representation of the dissolution characteristics of phytosterols over time in 0.01N HCl comparing different formulations—that is phytosterols with lecithin and a surfactant and a phytosterols without any excipients and as measured by turbidity.

### EXAMPLE 21

Hepatic Formulation

Hepatic formulation consisted of the following: 16.67 kg silymarin (70:1), 6.67 kg Bupleurum falcatum (5:1) and 6.67 kg Schisandra chinensis (16:1). This mixture was then added to 45.67 kg of phytosterol base and tabletised.

### EXAMPLE 22

Weight Control Formulation

The weight control formulation consisted of 3.33 kg of phaseolamin 2250. This was then added to 4.56 kg of phytosterol base and tabletised.

### EXAMPLE 23

Cholesterol Control Formulation

The cholesterol control formulation consisted of 5 kg Allium sativum (50:1), 12 mg folic acid, 6 mg cyanocobalamin, 2 kg pyridoxine hydrochloride and 0.5 kg coenzyme Q10. This mixture was then added to 68.5 kg phytosterol base and tabletised.

### EXAMPLE 24

HRT Formulation

HRT formulation consisted of 2 kg Glycine max (100:1), 0.4 kg Cimicimifuga racemosa. This was then mixed with 5.48 kg phytosterol base and tabletised.

### EXAMPLE 25

Antiarthritic Formulation

Antiarthritic formulation consisted of 5 kg glucosamine. This was mixed with 6.85 kg phytosterol base and tabletised.

### EXAMPLE 26

Antiarthritic Formulation

Antiarthritic formulation consisted of 5 kg chondroitin sulphate (MW 16000). This was mixed with 6.85 kg phytosterol base and tabletised.

### EXAMPLE 27

Antiarthritic or COX 2 Inhibitor Formulation

This formulation consisted of 5 kg of curcumin (95% pure) or berberine (95%) or boswellia or wilthania or a combination of all or 5 kg of hypogophytum. This was then mixed with 6.85 kg phytosterol base and tabletised.

### EXAMPLE 28

Examples 20 to 27 can also be used without the phytosterol base. Any water insoluble herb can also be used without the phytosterol base.

### EXAMPLE 29

Antiulcer Formulation

50 g of omeprazole (or any other proton pump inhibitor of the same family) and 40 g of liquid parrafin oil are mixed into a paste and while mixing 10 g liquid lecithin is added along with a surfactant preferably 10 g Cremophor EL or any other nonionic water soluble surfactant. FIGS. 3 and 4 show stability and dissolution studies of omeprazole.

### EXAMPLE 30

Liquid Dose Form

1 g of phytosterols

5 g D-limonene

1 g cremophor EL

0.5 g liquid Lecithin

Pharmacokinetics of Ginkgo Biloba

Human bioavailability study of Ginkgo biloba as measured by the levels of Quercetin, administered as Ginkgo biloba containing 24% flavonoids.

The table below shows that the Ginkgo biloba:lecithin complex, as described in Example 1, is more bioavailable than the straight Ginkgo biloba as measured by Quercetin, which is normally exceptionally poorly absorbed.

Ginkgo biloba was administered at a dose of 500 mg either as Ginkgo extract or Ginkgo:lecithin complex, containing the equivalent concentrations of flavanoids.

| | Plasma Levels of Quercetin ng/mL | | |
|---|---|---|---|
| | | | Ginkgo biloba: |
| Time | | Ginkgo biloba | lecithin complex |

| | | | | |
|---|---|---|---|---|
| 0 | 0 | | 0 | |
| 2 | 25 | | 50 | |
| 4 | 50 | | 350 | |
| 6 | 40 | | 250 | |
| 8 | 20 | | 100 | |
| AUC | 127 | ng/h/mL | 800 | ng/h/mL |

Stability of Ginkgo Biloba:Lecithin Complex as Measured by Quercetin, Kaempferol, Isorhamnetin

| 10 Months | 6 Months | 12 Months |
|---|---|---|
| 24.4% | 24.0% | 23.9% |

Pharmacokinetics of Silymarin

Pharmacokinetics of silymarin administered in various delivery systems, comparing a powdered extract of silymarin containing 28% silybin a and b and a silymarin:lecithin complex as described in Example 2 of silymarin containing the same amount of silybin a and b.

Silymarin was administered at a dose of 260 mg silybin a and b.

Blood samples were collected at 0, 2, 4, and 6 hours after administration and analysed by HPLC.

Silybin a and b were analysed as conjugated and unconjugated silybin a and b.

| | | |
|---|---|---|
| Time | | Silymarin |
| (hours) | Silymarin | Complex |

| | Plasma Levels of Conjugated | | | |
|---|---|---|---|---|
| | Silybin A and B - | | | |
| | Concentration in mg/mL | | | |
| 0 | 0 | | 0 | |
| 1 | 50 | | 680 | |
| 2 | 146 | | 774 | |
| 3 | 80 | | 630 | |
| 4 | 45 | | 480 | |
| 5 | 30 | | 460 | |
| 6 | 20 | | 450 | |
| AUC | 191 | ng/h/mL | 2032 | ng/h/mL |
| | Levels of Free Silybin A and B - | | | |
| | Concentration mg/mL | | | |
| 0 | 0 | | 0 | |
| 1 | 2 | | 29 | |
| 2 | 3 | | 56 | |
| 3 | 3 | | 41 | |
| 4 | 2 | | 33 | |
| 5 | 0 | | 25 | |
| 6 | 0 | | 15 | |
| AUC | 6 | ng/h/mL | 41 | ng/h/mL |

Stability of Silymarin:Lecithin Complex (at Room Temperature)

| | | |
|---|---|---|
| 0 Months | 6 Months | 12 Months |

Silymarin

| | | | | | |
|---|---|---|---|---|---|
| 100 | mg/g | 95 | mg/g | 95 | mg/g |

Silybin A & B

| | | | | | |
|---|---|---|---|---|---|
| 28 | mg/g | 26.5 | mg/g | 26 | mg/g |

Pharmacokinetics of d-α-tocopherol

The pharmacokinetcs of 500 IU d-α-tocopherol in soy bean oil, was compared to 500 IU of d-α-tocopherol complex as described in Example 3. The compositions were administered as a randomised cross over study to 12 human subjects and plasma levels of tocopherol measured.

Blood samples were collected at 0, 2, 4, 6, 8, 10, 24 hours and plasma levels of d-α-tocopherol was measured by HPLC.

| | Plasma Levels of Tocopherol uM | | |
|---|---|---|---|
| | | d-α-tocopherol | d-α-tocopherolas |
| Time | | in soya oil | lecithin complex |

| | | | | |
|---|---|---|---|---|
| 0 | 16 | | 20 | |
| 2 | 17 | | 24 | |
| 4 | 18 | | 26 | |
| 6 | 21 | | 29 | |
| 8 | 21 | | 30 | |
| 10 | 19 | | 27 | |
| 24 | 17 | | 31 | |
| AUC | 55 | μM/hr/L | 200 | μM/hr/L |

The Effects of Grape Seed Extract on UV Erythaema

Grape seed contains monomeric and polymeric forms of the condensed tannins catechin and epicatechin. A large body of evidence exists demonstrating the anti-carcinogenic activity of the related hydrolysable tannins, together with the known mechanisms by which UV radiation induces non-melanoma skin carcinogenesis. Indications are that UV induced immunosuppression are inhibitors of mixed lymphocyte reactions and has been shown to enhance the photocarcinogenic response in mice.

Thus it seems that the polyphenolic tannin and their derivatives interact with the process of photocarcinogenesis by interfering with the promotion phase, inhibiting critical promotional biochemistry, reducing synthesis of inflammatory mediators and protecting the immune response by any surveillance is sustained. Erythema in mice (hairless) due to topical treatment of grape seed (5% gel) before UV exposure and grape seed lecithin complex, using the composition of Example 5, (5% gel) and equal amounts of proanthocyanosides.

| | Skin thickness | | |
|---|---|---|---|
| | 48 h after | Mice | |
| | UVB exposure | numbers | % inhibition |
| Control | 56.5 ± 2.5 × 0.001 mm | 6 | |
| Grape Seed | 50.5 ± 1.5 × 0.001 mm | 6 | 11 |
| Grape Seed & | 30.2 ± 1.5 × 0.001 mm | 6 | 46% |
| Lecithin complex | | | |

P<0.001 between grape seed and grape seed complex.

Mice were contact sensitised with 0.3% DNFB and were challenged again 4 days later. The inflammatory reaction (contact hypersensitivity response) was measured as ear thickness. Results Indicate a decreased immune suppression due to UV exposure and Grape Seed:lecithin complex.

| | Ear swelling UV | Ear Swelling UV | % inhibition |
|---|---|---|---|
| Control | 16 × 0.01 mm | 6 × 0.01 mm | 62.5 |
| Grape Seed | 16 × 0.01 mm | 8 × 0.01 mm | 50% |
| Grape Seed: | 16 × 0.01 mm | 11 × 0.01 mm | 31.2 |
| Lecithin complex | | | |

P<0.01 between grape seed and grape seed complex.

Erythema in Mice Orally Given Grape Seed Extract at 150 mg/Kg/day as Grape Seed Extract Before UV Exposure and Grape Seed Lecithin Entity

| | Skin thickness after 48 hrs | Number | % |
|---|---|---|---|
| | UVB exposure | of mice | inhibition |
| Control | 53.5 ± 2.5 × 0.001 mm | 5 | |
| Grape Seed | 45.2 ± 1.5 × 0.001 mm | 5 | 16% |
| Grape Seed & | 35.2 ± 2.3 × 0.001 mm | 5 | 33% |
| Lecithin complex | | | |

These mice were sensitised with 0.3% DNFB and were challenged again 4 days later and showed a similar decrease in immune suppression as shown in this table.

Comparison of Green Tea, Pycnogenol, Silymarin, Soy and Combination of These Extracts as Immune Protectors

% suppression of contact hypersensitivity less hypersensitivity by UV

| | |
|---|---|
| Soy | 28% |
| Silymarin | 39% |
| Green Tea | 39% |
| Combination | 25% |
| Vehicle | 60% |
| Pycnogenol | 10% |
| Control | 60% |

All showed significant difference to UV suppression. Soy and combination P<0.01 when compared to vehicle and control. Green Tea and Silymarin showed significant difference when compared to vehicle and control. P<0.05. Pycnogenol showed significant difference at a level of P<0.001.

### INDUSTRIAL APPLICABILITY

It should be clear that the formulation and methods of this invention will find wide use in the medical, veterinary and cosmetic fields.

The foregoing describes only some embodiments of the present invention and modifications obvious to those skilled in the art can be made thereto without departing from the scope of the invention.

1. A process of preparing an emulsion of a solubilised compound, said compound being soluble in a physiologically acceptable aqueous or nonaqueous solvent, said process comprising:
(a) adding a complexing agent to at least one said solvent containing at least one said compound, the agent being capable of forming a compound:agent complex;
(b) adding an emulsifier to the solvent containing the compound and the complexing agent; and
(c) forming an emulsion.

2. A process of preparing a dispersion of a compound which is insoluble in a physiologically acceptable aqueous or nonaqueous solvent but only soluble in a physiologically unacceptable solvent, said process comprising:
(a) adding said compound to at least one physiologically acceptable solvent;
(b) adding a complexing agent to the compound plus solvent of (a);
(c) further adding an emulsifier to the compound plus solvent plus complexing agent of (b);
(d) forming a dispersion of said compound in said physiologically acceptable solvent.

3. The process according to claim 1 or claim 2, wherein the complexing agent is a phospholipid, organic phosphate, choline ester, succinate, amino ester, or amino acetate.

4. The process according to claim 3, wherein, the complexing agent is a naturally occurring or synthetic phospholipid.

5. The process according to claim 4, wherein the phospholipid has the following formula: 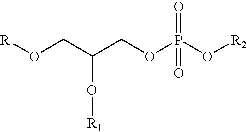
wherein R and R₁ are the same or different and are palmitate, stearate, oleate, linoleate, or linolinate, and R₂ is choline, ethanolamine or serine.

6. The process according to any one of claims 1 to 5, wherein the solvent is a polar solvent present as a single solvent or mixture of various solvents or a multiphasic mixture of two or more immiscible or substantially immiscible phases.

7. The process according to claim 6, wherein when the polar phase is a monophasic solution or is part of a multiphasic entity, the solvent is an alkanol, acetone, lower aralkanol, a glycol, glycerol, a pyrrolidone, vinegar, water or other suitable non toxic polar solvent, either singularly or in combination with any two.

8. The process according to claim 6 or claim 7, wherein the nonpolar phase is any substance that is not substantially immisible in the polar phase.

9. The process according to claim 8, wherein the non polar phase is a vegetable, animal, or non toxic mineral oil; a non toxic water immisible organic solvent, a triglyceride or fatty acid.

10. The process according to claim 9, wherein the non polar phase is a medium chain triglyceride.

11. The process according to claim 10, wherein the fatty acid moieties of the medium chain triglyceride are between C₄ and C₁₂.

12. The process according to claim 11, wherein the fatty acid moieties of the medium chain triglyceride are between C₈ and C₁₂.

13. The process according to claim 12, wherein the alkanol is ethanol, propanol, polyvinyl alcohol, iso-propanol; the glycol is a lower polyalkylene glycol or a lower alkylene glycol, the pyrrolidone is polyvinyl pyrrolidone, methyl pyrrolidone or 2 pyrrolidone.

14. The process according to claim 6, wherein the multiphasic mixture of two or more immiscible or substantially immiscible phases comprises a polar phase and a non polar phase a multiphasic entity.

15. The process according to claim 14, wherein the multiphasic entity is a water/oil or glycol/oil multiphasic entity.

16. The process according to claim 2, wherein when the complexing agent is a phospholipid, said phospholipid is dissolved in a medium chain triglyceride.

17. The process according to claim 16, wherein the concentration of phospholipid in medium chain triglyceride is about 25 wt %.

18. The process according to any one of claims 1 to 17, wherein the temperature in step (a) is from about 30° C. to about 95° C.

19. The process according to claim 18, wherein the temperature is from about 35° C. to about 90° C.

20. The process according to claim 19, wherein the temperature is from about 40° C. to about 85° C.

21. The process according to claim 20, wherein the temperature is from about 45° C. to about 80° C.

22. The process according to claim 21, wherein the temperature is from about 50° C. to about 70° C.

23. The process according to any one of claims 1 to 22, wherein the emulsifier is a combination of emulsifiers.

24. The process according to claim 23, wherein the combination of emulsifiers comprises 2, 3, 4, 5, 6, 7, 8, 9, 10 or more different emulsifiers.

25. The process according to claim 24, wherein the emulsifiers are polyoxyethylene stearates (eg. polyoxyethylene(40) stearate), polyoxyethylene oleates, polyoxyethylene laurates, polyoxyethylene caster oil derivatives, sorbitan esters, or polyoxyethylene sorbitan fatty acid esters.

26. The process according to claim 25, wherein the emulsifiers are polysorbate 60 in combination with cremophor EL or cremophor RH40.

27. The process according to claim 26, wherein the ratio of polysorbate to cremophor is 25:75 wt:wt.

28. The process according to any one of claims 1 to 27, wherein the total amount of emulsifier in the complexed mixture is from 1 to 99 wt %.

29. The process according to claim 28, wherein the concentration is from 15 to 50 wt %.

30. The process according to claim 29, wherein the concentration is from 20 to 45 wt %.

31. The process according to claim 30, wherein the concentration is from 25 to 43 wt %.

32. The process according to claim 31, wherein the concentration is from 30 to 40 wt %.

33. The process according to any one of claims 1 to 32, wherein the emulsion is in the form of micelles which contain said at least one compound or a complex between said at least one compound and complexing agent; and emulsifying agent.

34. The process according to any one of claims 1 to 33, wherein when the compound (as hereinbefore described) is a plant extract, the weight ratio of phospholipid to active in the plant extract is from 0.1:1 to 5:1.

35. The process according to claim 34, wherein the weight ratio is 0.1:1 to 2:1.

36. The process according to any one of claims 1 to 35, wherein when the compound is a mineral, vitamin, peptide, antibiotic, anthelmintic, insect growth regulator or other anti insect drug, herbicide, glucosamine, chondroitin sulphate and a benzimidazole, the weight ratio of phospholipid to active is in the range 0.01:1 to 2:1.

37. The process according to any one of claims 1 to 36, wherein when the compound or compounds to be complexed.

38. The process according to claim 37, wherein partitioning is brought about by agitation in a multiphasic composition, the agitation being either ultrasonic, mechanical or by shaking.

39. The process according to any one of claims 1 to 38, wherein the temperature range for forming the emulsion is from about 20° C. to about 95° C.

40. The process according to claim 39, wherein the temperature range is about 25° C. to about 95° C.

41. The process according to claim 40, wherein the temperature range is about 30° C. to about 95° C.

42. The process according to claim 41, wherein the temperature range is about 35° C. to about 90° C.

43. The process according to claim 42, wherein the temperature range is about 40° C. to about 85° C.

44. The process according to claim 43, wherein the temperature range is about 45° C. to about 80° C.

45. The process according to claim 44, wherein the temperature range is about 50° C. to about 70° C.

46. The process according to claim 45, wherein the temperature range is about 20° C. to about 70° C.

47. The process according to any one of claims 1 to 46, wherein in step (a) the complexing agent is a phospholipid; in step (b) the emulsifier is a first emulsifier; and step (b) is a followed by the following step:
(b′) adding a second emulsifier to the solvent containing the compound and phospholipid and the first emulsifier; and
wherein step (c) comprises forming the compound:agent complex and an emulsion; and
wherein the step of forming a compound:phospholipid complex occurs during at least one of steps (a) to (c).

48. An emulsion when prepared by the process according to any one of claims 1 or 3 to 47.

49. The emulsion according to claim 48 wherein the compound is one or more compounds selected from the group comprising flavonoids, gingko biloba extract, silymarin, tocopherol acetate, coenzyme Q10, grape seed extract, a mineral, a peptide, an antibiotic, an insect growth regulator or other anti insect drug, herbicide, glucosamine, chondroitin sulphate and a benzimidazole.

50. The emulsion of claim 49 wherein the mineral is molybdenum, vanadium, and/or cobalt.

51. The emulsion of claim 49 wherein the peptide is insulin.

52. The emulsion of claim 49 wherein the antibiotic is vancomycin, amoxicillan, and/or amoxicillan and clavulanic acid.

53. The emulsion of claim 49 wherein the insect growth regulator is methoprene.

54. A composition comprising an emulsion prepared by the process according to any one of claims 1 or 3 to 47 or an emulsion according to any one of claims 49 to 54, together with an acceptable adjuvant, excipient, diluent, additive and/or carrier.

55. A dispersion when prepared by the process according to any one of claims 2 to 46.

56. A dispersion wherein the compound is one or more compounds selected from the group consisting of phytosterols, carotenoids, tocopherols, other phytochemicals, soy extract, green tea extract, pycnogenol, grape seed extract.

57. The dispersion according to claim 56 wherein the tocopherol is α-d-tocopherol.

58. A composition comprising a dispersion prepared by the process according to any one of claims 1 to 46 or a dispersion according to any one of claims 55 to 57, together with an acceptable adjuvant, excipient, diluent, additive and/or carrier.

59. The emulsion according to claim 48 wherein at least two compounds are chosen such that at least one compound is stable at acid pH and at least one other compound is stable at alkaline pH.

60. The emulsion according to claim 59 wherein the compound stable at acid pH is levamisole and the compound stable at alkaline pH is closantel.

61. The emulsion according to claim 48 wherein the at least one compound is unstable at acid pH.

62. The emulsion according to claim 61 wherein said compound is omeprazole.

63. The dispersion according to claim 55 wherein the compound stable at acid pH is levamisole and the compound stable at alkaline pH is closantel.

64. The dispersion according to claim 63 wherein said compound is omeprazole.

65. The emulsion and/or dispersion according to any one of claims 48 to 64 in solid or liquid form.

66. A method of administering a compound to an animal comprising administering an emulsion or dispersion when prepared by the process according to any one of claims 1 to 48 or a composition according to any one of claims 48 to 65, to the animal.

67. The method according to claim 66 wherein administration is effected orally.

68. A method of administering a compound to an animal comprising administering an emulsion or dispersion when prepared by the process according to any one of claims 1 to 47 or a composition according to any one of claims 48 to 60, to the animal.

69. The method according to claim 68 wherein administration is effected transdermally.
